(19) United States
(12) Patent Application Publication
(10) Pub. No.: US 2004/0234648 A1
(43) Pub. Date: Nov. 25, 2004

(54) Syrups containing sorbitol, a plasticizing agent and hydrogenated starch hydrolyzate, and their use in chewing gum and other confectionaries

(76) Inventors: Pamela M. Mazurek, Orland Park, IL (US); Michael A. Reed, Merrillville, IN (US); Meghan A. Dwyer, Chicago, IL (US); Thomas R. Koziel, Chicago, IL (US)

Correspondence Address: WRIGLEY & DREYFUS 28455, BRINKS HOFER GILSON & LIONE, P.O. BOX 10395, CHICAGO, IL, 60610, US

(21) Appl. No.: 10/767,414

(22) Filed: Jan. 27, 2004

Related U.S. Application Data
(60) Provisional application No. 60/443,037, filed on Jan. 27, 2003.

(51) Int. Cl. A23G 3/30

(52) U.S. Cl. 426/3

(57) ABSTRACT

A chewing gum including non-crystalline sorbitol and method of making the same is provided. The chewing gum composition comprises a sugarless syrup made from aqueous sorbitol, a plasticizing agent selected from the group consisting of glycerin, propylene glycol and mixtures thereof, and a hydrogenated starch hydrolyzate syrup. Other confectionaries can be made from the same sugarless syrup.

### REFERENCE TO RELATED APPLICATION

The present application claims the benefit of the filing date under 35 U.S.C. § 119(e) of Provisional U.S. Patent Application Ser. No. 60/443,037, filed Jan. 27, 2003, which is hereby incorporated by reference in its entirety.

### BACKGROUND

The present invention relates generally to chewing gums and other confectionaries. More specifically, the present invention relates to chewing gums and other confectionaries including sorbitol.

It is known to include alditols, such as sorbitol, mannitol, and xylitol, in chewing gums and other confectionaries. Alditols can be used in chewing gum, as well as other confectioneries and food products, as a “sugar substitute.” These sugar substitutes have the advantage that they are not fermented in the mouth of the consumer to form products that can attack dental enamel. Therefore, sorbitol, as well as other alditols, are generally used in sugarless products. Additionally, sorbitol can be used as a bulking agent.

A number of patents have disclosed and discussed the use of various compositions including sorbitol. U.S. Pat. No. 3,857,965 discloses a chewing gum composition made from melting crystalline sorbitol and mixing the melted sorbitol with gum base and a crystallization retardant. U.S. Pat. No. 4,156,740 to Glass et al., U.S. Pat. No. 4,250,196 to Friello, U.S. Pat. No. 4,252,829 to Terrevazzi and U.S. Pat. No. 4,466,983 to Cifrese et al. disclose liquid compositions containing sorbitol used as a centerfill for chewing gum. U.S. Pat. No. 5,120,551 to Yatka et al. discloses a syrup containing sorbitol and other alditols used in chewing gum compositions.

Several patents disclose a syrup for use in chewing gum which is made by mixing glycerin or propylene glycol with an aqueous hydrogenated starch hydrolysate (HSH) such as Lycasin brand HSH from Roquette, including U.S. Pat. Nos. 4,671,961; 4,671,967 and 4,728,515 to Patel et al., each of which are hereby incorporated by reference. It is believed that Lycasin brand HSH contains, on a dry basis, about 6% sorbitol, about 52% maltitol and about 42% of oligosaccharides having a degree of polymerization (“DP”) of 3 or greater.

Sorbitol can be provided in chewing gum in its crystalline form. It is believed that crystalline sorbitol currently accounts for approximately 50% of typical sugarfree chewing gum formulations. Unfortunately, crystalline sorbitol is costly. Although it would be desirable to have a replacement for crystalline sorbitol, heretofore, such possible replacements were not as effective, created product stability problems, created processability issues, were even more expensive than crystalline sorbitol, and/or could not be used with certain formulations.

In this regard, aqueous sorbitol has been explored for use in chewing gum. Sorbitol in an aqueous solution is a less expensive alternative, on a dry basis, than crystalline sorbitol. Unfortunately, the use of aqueous sorbitol in chewing gum at levels above 15% can create problems with respect to product stability. Likewise, the use of aqueous sorbitol at levels above 15% can also create processability problems. This is due, it is believed, to the water content contained in the aqueous sorbitol.

Additionally, there are problems with respect to at least certain chewing gum formulations when using sorbitol in an aqueous solution. Because typical aqueous sorbitol solutions contain about 30% water, the water added with the sorbitol is detrimental to moisture sensitive ingredients when sorbitol solution is provided at high levels in chewing gum. A further difficulty with aqueous sorbitol is that it readily crystallizes and causes the gum to become brittle. While Lycasin brand HSH contains a small amount of sorbitol, it does not provide a significant amount of sorbitol such that HSH can be substituted for crystalline sorbitol.

U.S. Pat. No. 5,651,936 discloses a unique syrup composition containing aqueous sorbitol, a plasticizer agent, and an anticrystalizing agent. This composition was designed to use aqueous sorbitol as a less expensive form of sorbitol, but overcoming the foregoing problems. While this syrup was successfully used in chewing gum compositions used to make stick forms of chewing gum products, its use in other forms, particularly coated pellet gum, at a level great enough to be economically advantageous, was not satisfactory. Of course, other chewing gum formulations without the syrup can be made and used to form pellets for coated chewing gum products. However, it would be advantageous if a syrup made with the low cost form of sorbitol could be developed that could be used in pellet gum compositions. More importantly, it would be highly advantageous if a single syrup could be made that used inexpensive aqueous sorbitol and that could be used both in stick gum as well as other forms of chewing gum, so that only one sugarless syrup would be needed to make all types of products. It would especially be beneficial if the syrup could be used at levels such that the cost benefit of the low cost of the syrup made its use worthwhile from a practical standpoint.

There is therefore a need for a sugarless syrup that allows sorbitol in a non-crystalline state to be added to a chewing gum formulation that can be made into pellet gum, as well as added to stick gum formulations or other confections.

### BRIEF SUMMARY

The preferred embodiment of the present invention provides a sugarless syrup that surprisingly can be used in both stick and pellet chewing gum compositions, providing lower cost and improved chewing gum compositions. The preferred syrup can be used at levels which are high enough that the cost savings justify its use. More specifically, the present invention provides a chewing gum composition that includes an aqueous syrup containing sorbitol, a plasticizing agent and hydrogenated starch hydrolyzate. Additionally, the present invention also provides other products such as food stuffs, beverages, medicaments, and confectioneries that include the inventive aqueous sugarless syrup. Pursuant to the present invention, the sugarless syrup can be used in pellet gum formulations that contain levels of liquid sorbitol solution that were heretofore not possible.

In one aspect, the invention is a method of making a chewing gum composition comprising the steps of:

a) making a syrup by evaporating water from a mixture comprising:

i) an aqueous sorbitol solution containing at least 50% sorbitol;

ii) a plasticizing agent selected from the group consisting of glycerin, propylene glycol and mixtures thereof; and

iii) a hydrogenated starch hydrolyzate syrup,

iv) wherein the final evaporated syrup composition comprises less than 10% moisture, about 5% to about 20% plasticizing agent, at least 50% sorbitol, about 3% to about 25% maltitol, and at least 1.5% hydrogenated oligosaccharides having a DP of 3 or greater; and

b) mixing the syrup with gum base and additional chewing gum ingredients to produce the chewing gum composition.

In a second aspect, the invention is a chewing gum composition comprising a homogeneous mixture of gum base and a bulking agent wherein the bulking agent comprises an aqueous sugarless syrup comprising at least 50% sorbitol, about 3% to about 25% maltitol, about 8% to about 20% plasticizing agent and at least 1.5% hydrogenated oligosaccharides having a DP of 3 or greater and wherein the chewing gum composition has less than 2% moisture and said syrup comprises over 30% of said composition.

In a third aspect, the invention is an aqueous syrup for use in making both stick and pellet chewing gum products comprising, on a dry basis:

a) about 60% to about 80% sorbitol,

b) about 8% to about 15% plasticizing agent selected from the group consisting of glycerin, propylene glycol and mixtures thereof, and

c) about 5% to about 30% hydrogenated starch hydrolyzate, the hydrogenated starch hydrolyzate containing hydrogenated oligosaccharides having a DP of at least 3 or greater of at least 1.5% of the dry basis of the syrup, and at least 4% maltitol on the dry basis of the syrup.

In a fourth aspect, the invention is a method of making a syrup for use in both stick and pellet chewing gum products comprising the steps of:

a) providing sorbitol in an aqueous solution having a solids content of at least about 50% sorbitol and about 30% to about 50% water;

b) mixing said sorbitol solution with

i) a plasticizing agent selected from the group consisting of glycerin, propylene glycol and mixtures thereof, and

ii) a hydrogenated starch hydrolyzate syrup containing, by weight of the hydrogenated starch hydrolyzate syrup, at least 50% maltitol and at least 10% hydrogenated oligosaccharides having a DP of 3 or greater; and

c) removing moisture from said mixture to produce a syrup having a moisture content of less than about 10%.

In a fifth aspect, the invention is a method of making at least two different chewing gum compositions, at least one of the compositions being used to make stick chewing gum products and at least one of the compositions being used to make coated chewing gum products, comprising the steps of:

a) evaporating a mixture comprising sorbitol solution, glycerin and hydrogenated starch hydrolyzate syrup to form an evaporated sugarless syrup; and

b) mixing the evaporated sugarless syrup with a first set of additional chewing gum ingredients comprising gum base, a sugarless bulk sweetener and a flavoring agent, to form a first chewing gum composition;

c) forming the first chewing gum composition into stick chewing gum products;

d) mixing the evaporated sugarless syrup with a second set of additional chewing gum ingredients different than the first set of additional chewing gum ingredients, the second set of additional chewing gum ingredients comprising gum base, a sugarless bulk sweetener and a flavoring agent, to form a second chewing gum composition;

e) forming the second chewing gum composition into cores; and

f) coating the cores with a sugarless coating.

In a sixth aspect, the invention is a chewing gum formulation comprising:

a) a water insoluble gum base; and

b) a water soluble portion which includes sorbitol, the sorbitol being present, at least initially, in the formulation as a syrup of aqueous sorbitol and comprising approximately 25% to about 65% by weight of the formulation, the syrup being created by coevaporating a solution that comprises, prior to coevaporation, approximately 52% to about 87% by weight aqueous sorbitol, approximately 5% to about 30% by weight of a hydrogenated starch hydrolyzate syrup and approximately 8% to about 20% by weight of a plasticizing agent selected from the group consisting of glycerin, propylene glycol and mixtures thereof.

In a seventh aspect, the invention is a method for creating chewing gum compositions for use in making stick chewing gum products and chewing gum compositions used to make coated pellet chewing gum products comprising the steps of:

a) coevaporating a solution that comprises, prior to coevaporation, approximately 52% to about 87% by weight aqueous sorbitol, approximately 5% to about 30% by weight of hydrogenated starch hydrolyzate syrup, and approximately 8% to about 20% by weight of a plasticizing agent selected from the group consisting of glycerin, propylene glycol and mixtures thereof;

b) using the syrup to make a first chewing gum composition for stick chewing gum products, wherein the syrup comprises about 40% to about 65% of the first chewing gum composition; and

c) using the syrup to make a second chewing gum composition for coated pellet chewing gum products, wherein the syrup comprises about 30% to about 55% of the second chewing gum composition.

In an eighth aspect, the invention is a method for producing chewing gum that includes sorbitol comprising the steps of:

a) providing a syrup consisting essentially of:

i) aqueous sorbitol,

ii) a plasticizing agent selected from the group consisting of glycerin, propylene glycol and mixtures thereof, and

iii) hydrogenated starch hydrolyzate syrup,

b) evaporating water from the syrup; and

c) combining the evaporated syrup to additional chewing gum ingredients to create a chewing gum formulation.

In a ninth aspect, the invention is a sorbitol-containing product comprising a syrup consisting essentially of:

a) aqueous sorbitol,

b) a plasticizing agent selected from the group consisting of glycerin, propylene glycol and mixtures thereof; and

c) hydrogenated starch hydrolyzate syrup.

An advantage of an embodiment of the present invention is that it provides an improved pellet chewing gum formulation for making coated chewing gum products. Using this embodiment of the invention, sorbitol can be used in the pellet chewing gum composition in a state other than a crystalline state. This provides a more cost effective method of adding sorbitol to a pellet chewing gum composition.

Another advantage of the preferred embodiment of the invention is that the same sugarless syrup can be used to make pellet gum compositions that are sturdy enough to be coated in normal panning operations, and stick gum compositions that have cohesiveness and flexibility.

Additional features and advantages of the present invention are described in, and will be apparent from, the detailed description of the presently preferred embodiments.

### DETAILED DESCRIPTION OF THE PRESENTLY PREFERRED EMBODIMENTS

All percentages herein are weight percentages unless otherwise specified. As used herein, the term “chewing gum” also includes bubble gum and the like.

The present invention provides improved chewing gum formulations and methods of making chewing gum. Pursuant to the present invention, sorbitol is provided in a non-crystalline state at levels in pellet gum formulations that the inventors believe were not heretofore commercially possible utilizing liquid sorbitol.

Sorbitol can be added either alone, with other sugarless sweeteners, for example, in sugarfree chewing gum, or in combination with sugar sweeteners. Additionally, the sorbitol can be provided in the chewing gum entirely in the syrup form of the present invention, or along with a crystalline form of sorbitol.

Pursuant to the present invention, the sorbitol is added to other components of a chewing gum formulation as a coevaporated blend of aqueous sorbitol, a plasticizing agent, and hydrogenated starch hydrolyzate syrup. The blend of aqueous sorbitol is provided as a sugarless syrup. This blend can be used to reduce the usage of crystalline sorbitol in pellet chewing gum formulations. It has been found that the resultant product, including the sugarless syrup of the present invention, exhibits increased binding capacity over currently used binders in sugar-free gum.

The preferred syrup of the present invention comprises, on a dry basis, about 30% to about 80% sorbitol, about 8% to about 20% of a plasticizing agent, and about 5% to about 30% of a hydrogenated starch hydrolyzate solids. More preferably, the syrup comprises, on a dry basis, about 50% to about 70% sorbitol, about 8% to about 15% plasticizing agent and about 5% to about 25% hydrogenated starch hydrolyzate solids. For some purposes, the syrup will comprise about 60% to about 80% sorbitol, about 8% to about 15% plasticizing agent and about 5% to about 25% hydrogenated starch hydrolyzate solids containing maltitol and at least 1.5% (by weight of the syrup) hydrogenated oligosaccharides having a DP of 3 or higher. A presently preferred syrup contains about 70% sorbitol, about 13% plasticizing agent and about 15% hydrogenated starch hydrolyzate solids.

Sorbitol for use in the inventive syrup will preferably be provided initially in the form of an aqueous solution. The aqueous sorbitol solution will preferably contain at least 50% sorbitol, more preferably about 60% sorbitol, and most preferably about 70% sorbitol. Preferably the remainder of the solution is water. A commonly available sorbitol solution is Neosorb 70/02 from Roquette Corporation, which contains 70% sorbitol and about 30% water. It is believed that there are small amounts (about 0.75% to about 1.5%) of mannitol in this typical sorbitol solution by way of an impurity. This amount of mannitol normally present is insufficient to prevent crystallization when the sorbitol solution is evaporated with the plasticizing agent to low moisture levels.

The plasticizing agent of the syrup of the present invention is selected from the group consisting of glycerin, propylene glycol and mixtures thereof. While the plasticizing agent may help prevent crystallization, its main function is to keep the syrup, with high solids level, fluid at room temperature. The ratio of alditols to plasticizing agent in the syrup will preferably be between about 20:1 and about 4:1, more preferably between about 10:1 and about 5:1, and most preferably between about 7:1 and about 6:1.

The hydrogenated starch hydrolyzate syrup provides two benefits. First, it prevents the sorbitol from crystallizing as high solids levels are reached while evaporating water from the syrup. Second, the preferred hydrogenated starch hydrolyzate syrup will provide flexibility to the stick gum formulations and robustness and cohesiveness to the pellet gum formulations. In this regard the preferred syrup should have a weight average degree of polymerization (DP) of at least 2.6, with at least 10% of the alditols in the syrup having a DP of 3 or greater. Preferably the alditols with a DP of 3 or greater will, as a group, have a weight average degree of polymerization of between about 4 and about 5. Preferably, a hydrogenated starch hydrolyzate syrup with a high maltitol content should be used, preferably about 52% to about 89% maltitol, with about 1% to about 6% sorbitol, and about 10% to about 42% hydrogenated oligosaccharides having a DP of 3 or greater. The preferred hydrogenated starch hydrolyzate syrup will have less than 30% water, more preferably about 20% to about 25% water. A particularly preferred syrup is C* Maltidex M 16311 from Cerestar, which has a solids content of about 74.5%, and contains about 56.6% malitol (about 76% on a dry basis), about 1.5% sorbitol (about 2% on a dry basis) and about 16.4% hydrogenated oligosaccharides having a DP of 3 or greater (about 22% on a dry basis). It is believed that the weight average degree of polymerization of the oligosaccharides having a DP of 3 or greater is between about 4 and about 5.

The ratio of sorbitol to hydrogenated starch hydrolyzate solids in the sugarless syrup of the present invention will preferably be between about 15:1 and about 2:1, more preferably between about 10:1 and about 3:1, most preferably between about 5:1 and about 4:1. Preferably over 50% of the combined alditols in the syrup will have a DP of 1, and most preferably the sorbitol comprises over 60% of the alditols.

Generally, to make the aqueous sugarless syrup of the present invention, aqueous sorbitol, a plasticizing agent and hydrogenated starch hydrolyzate syrup are mixed together and then coevaporated under vacuum to create a syrup. Preferably, the aqueous sorbitol, plasticizer agent and hydrogenated starch hydrolyzate syrup combination is evaporated so that it contains not more than 10% water. More preferably, the aqueous sorbitol, plasticizing agent and anticrystallization agent mixture is evaporated so that it contains no more than 7% water, even more preferably no more than about 5% water, and most preferably about 2% to about 4% water. Particularly preferred embodiments are evaporated to contain about 3% water.

A stick gum can be made using the syrup described in Examples 1-9 in U.S. Pat. No. 5,651,936. This gum is easily made into a flat stick gum product that is sufficiently tough, but flexible for gum wrapping equipment. The sensory qualities of the product were a sweet, clean flavor and sweetener, and gave a consumer acceptable shelf life.

Gum made using the same syrup in pellet form is not satisfactory. Pellet gum centers require sufficient toughness and robustness so that pellet centers can be coated in panning equipment. A pellet gum made with only 20% of the syrup described in Examples 1-9 of U.S. Pat. No. 5,651,936 was marginally acceptable, but this level of use still required the use of significant amounts of crystalline sorbitol, and was not cost effective. From other experience, it was predicted that a pellet gum made with sufficiently high levels of the prior syrup would be too soft for coating and become damaged during processing. Also, the high level of glycerin in the center would make it difficult to dry the various polyol coatings used in the coating processes. In addition, the high glycerin content would cause a loss in shelf life of coated pellet gums due to glycerine migration and absorption of moisture, causing the gum pellets to lose their crunch and have poor shelf life.

On the other hand, the preferred sugarless syrup of the present invention can be used in both stick gum and pellet gum, yet both products have the overall quality needed for manufacturing and consumer acceptance.

This improved syrup uses less glycerin and contains hydrogenated starch hydrolyzate solids, and can give a tougher, more cohesive gum center for pellet coating, while at the same time give an acceptable quality stick gum, and can even be used in a stick gum formula at a higher level than in the products using the syrup of Example 1-9 of U.S. Pat. No. 5,651,936. This higher level of the sugarless syrup can reduce the overall cost of the stick gum formula, while keeping its good product texture and improved shelf life.

The new sugarless syrup surprisingly can be used in stick, tab, chunk or pellet chewing gum products, especially pellets that are to be coated. It is a great advantage to chewing gum manufacturers to use the same ingredients in all of their chewing gum compositions, which are then used to make stick products, tab products, pellets for coating, or gum balls.

The aqueous sorbitol, plasticizing agent and hydrogenated starch hydrolyzate can be provided in different combinations and ratios. Preferably, the syrup will be made from a mixture of about 52% to about 87% aqueous sorbitol solution, about 8% to about 20% plasticizing agent and about 5% to about 30% hydrogenated starch hydrolyzate. More preferably, the syrup will be made from a mixture of about 60% to about 75% sorbitol solution, about 8% to about 15% plasticizing agent and about 8% to about 20% hydrogenated starch hydrolyzate syrup.

The aqueous sorbitol syrup of the present invention will most frequently be the only syrup needed in the chewing gum formulation, whether the gum is in stick, tab, or pellet form. However, in some formulations, other aqueous syrups or solutions may be desired.

Pursuant to the present invention, the aqueous sorbitol syrup can be used to create sugarless chewing gums, because sugarless chewing gum typically contains sorbitol. However, it should be noted that the present invention can be used to create any chewing gum that includes sorbitol. Likewise, the inventive sugarless syrup can be used in other products that use sorbitol. Such products include confectioneries, medicaments, beverages and food products.

Chewing gum generally consists of a water insoluble gum base, a water soluble portion, and flavors. The water soluble portion dissipates with a portion of the flavor over a period of time during chewing. The gum base portion is retained in the mouth throughout the chew.

The insoluble gum base generally comprises elastomers, resins, fats and oils, softeners, and inorganic fillers. The gum base may or may not include wax. The insoluble gum base can constitute approximately 5 to about 95 percent, by weight, of the chewing gum. More commonly, the gum base comprises 10 to about 50 percent of the gum, and, in some preferred embodiments, 20 to about 35 percent, by weight, of the chewing gum.

In an embodiment, the chewing gum base of the present invention contains about 20 to about 60 weight percent synthetic elastomer, 0 to about 30 weight percent natural elastomer, about 5 to about 55 weight percent elastomer plasticizer, about 4 to about 35 weight percent filler, about 5 to about 35 weight percent softener, and optional minor amounts (about one percent or less) of miscellaneous ingredients such as colorants, antioxidants, etc.

Synthetic elastomers may include, but are not limited to, polyisobutylene with a GPC weight average molecular weight of about 10,000 to about 95,000, isobutylene-isoprene copolymer (butyl elastomer), styrene-butadiene copolymers having styrene-butadiene ratios of about 1:3 to about 3:1, polyvinyl acetate having a GPC weight average molecular weight of about 2,000 to about 90,000, polyisoprene, polyethylene, vinyl acetate-vinyl laurate copolymer having vinyl laurate content of about 5 to about 50 percent by weight of the copolymer, and combinations thereof.

Preferred ranges are, for polyisobutylene, 50,000 to 80,000 GPC weight average molecular weight; for styrene-butadiene, 1:1 to 1:3 bound styrene-butadiene; for polyvinyl acetate, 10,000 to 65,000 GPC weight average molecular weight, with the higher molecular weight polyvinyl acetates typically used in bubble gum base; and for vinyl acetate-vinyl laurate, vinyl laurate content of 10-45 percent.

Natural elastomers may include natural rubber such as smoked or liquid latex and guayule as well as natural gums such as jelutong, lechi caspi, perillo, sorva, massaranduba balata, massaranduba chocolate, nispero, rosindinha, chicle, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers may include, but are not limited to, natural rosin esters such as glycerol esters of partially hydrogenated rosin, glycerol esters of polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing. The preferred elastomer plasticizers will also vary depending on the specific application and on the type of elastomer which is used.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners may include FD&C-type dyes and lakes, fruit and vegetable extracts, titanium dioxide, and combinations thereof.

The base may or may not include wax. An example of a wax-free gum base is disclosed in U.S. Pat. No. 5,286,500, the disclosure of which is incorporated herein by reference.

In addition to a water insoluble gum base portion, a typical chewing gum composition includes a water soluble bulk portion and one or more flavoring agents. The syrup of the present invention, containing water soluble ingredients, forms part of the water soluble bulk portion. The water soluble portion can also include powdered bulking agents (most typically bulk sweeteners), high-intensity sweeteners, flavoring agents, softeners, emulsifiers, colors, acidulants, fillers, antioxidants, and other components that provide desired attributes.

Softeners are added to the chewing gum in order to optimize the chewability and mouth feel of the gum. The softeners, which are also known as plasticizers and plasticizing agents, generally constitute between approximately 0.5 to about 15% by weight of the chewing gum. The softeners may include glycerin, lecithin, and combinations thereof. Aqueous sweetener solutions such as those containing sorbitol, hydrogenated starch hydrolyzate, corn syrup and combinations thereof, may also be used as softeners and binding agents in chewing gum. Thus, the sugarless syrup of the present invention can be used as a softener and binding agent.

Bulk sweeteners include both sugar and sugarless components. Bulk sweeteners and other bulking agents typically constitute about 5 to about 95% by weight of the chewing gum, more typically, about 20 to about 80% by weight, and more commonly, about 30 to about 60% by weight of the gum.

Sugar sweeteners generally include saccharide-containing components commonly known in the chewing gum art, including, but not limited to, sucrose, dextrose, maltose, dextrin, dried invert sugar, fructose, levulose, galactose, corn syrup solids, and the like, alone or in combination.

Generally, the sugarless syrup of the present invention comprises about 20% to about 65% of the chewing gum formulation. Typically the syrup will comprise approximately 40% to about 65% of stick chewing gum compositions, and about 30% to about 55% of pellet chewing gum compositions. Preferably the syrup will comprise at least about 40% of the gum, more preferably more than 45% of the gum, and most preferably more than 50% of the gum composition when used to make stick gum. For pellet chewing gum compositions, the preferred syrup level is at least about 30%, more preferably at least about 35% and most preferably more than 40% of the gum composition.

As noted above, in addition to the sugarless syrup of the present invention, crystalline sorbitol, if desired, can also be used. Additionally, sugarless sweeteners can include, but are not limited to, other sugar alcohols such as mannitol, xylitol, hydrogenated starch hydrolyzate, maltitol, and the like, alone or in combination.

High-intensity artificial sweeteners can also be used in combination with the above. Preferred sweeteners include, but are not limited to sucralose, aspartame, salts of acesulfame, alitame, saccharin and its salts, cyclamic acid and its salts, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Usage level of the artificial sweetener will vary greatly and will depend on such factors as potency of the sweetener, rate of release, desired sweetness of the product, level and type of flavor used and cost considerations. Thus, the active level of artificial sweetener may vary from 0.02 to about 8%. When carriers used for encapsulation are included, the usage level of the encapsulated sweetener will be proportionately higher.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Example of low caloric bulking agents include: polydextrose, Raftilose, Raftilin, fructooligosaccharides (NutraFlora), palatinose oligosaccharide, guar gum hydrolysate (Sun Fiber), and indigestible dextrin (Fibersol). However, other low calorie bulking agents can be used.

A variety of flavoring agents can be used. The flavor can be used in amounts of approximately 0.1 to about 15 weight percent of the gum, and preferably, about 0.2 to about 5%. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion.

The present invention, it is believed, can be used with a variety of processes for manufacturing chewing gum.

Chewing gum is generally manufactured by sequentially adding the various chewing gum ingredients to commercially available mixers known in the art. After the ingredients have been thoroughly mixed, the chewing gum mass is discharged from the mixer and shaped into the desired form, such as by rolling into sheets and cutting into sticks, extruding into chunks, or casting into pellets.

Generally, the ingredients are mixed by first melting the gum base and adding it to the running mixer. The gum base may alternatively be melted in the mixer. Color and emulsifiers can be added at this time.

The sugarless syrup of the present invention can be added next along with any other syrup softeners or bulking agents. Any bulk powdered sweeteners may be added in next, or divided and part added in at different times. Flavoring agents are typically added with the final part of any bulk sweetener. The entire mixing process typically takes from 5 to 15 minutes, although longer mixing times are sometimes required. Those skilled in the art will recognize that variations of this general mixing procedure, or other mixing procedures, can be followed.

The entire mixing procedure typically takes from five to fifteen minutes, but longer mixing times may sometimes be required. Those skilled in the art will recognize that many variations of the above described procedure may be followed.

In this invention, pellets of gum are prepared as conventional chewing gum but formed into pellets that are balls or pillow-shaped. The pellets can be then polyol coated or panned by conventional panning techniques to make a unique coated pellet gum. The weight of the coating may be about 20% to about 50% of the weight of the finished product, but may be as much as 75% of the total gum product.

Conventional panning procedures generally coat with sucrose, but recent advances in panning have allowed use of other carbohydrate materials to be used in place of sucrose. Some of these components include, but are not limited to, dextrose, maltose, palatinose, xylitol, lactitol, hydrogenated isomaltulose, erythritol, maltitol, and other new alditols or combinations thereof. These materials may be blended with panning modifiers including, but not limited to, gum arabic, maltodextrins, corn syrup, gelatin, cellulose type materials like carboxymethyl cellulose or hydroxymethyl cellulose, starch and modified starches, vegetables gums like alginates, locust bean gum, guar gum, and gum tragacanth, insoluble carbonates like calcium carbonate or magnesium carbonate and talc. Antitack agents may also be added as panning modifiers, which allow the use of a variety of carbohydrates and alditols to be used in the development of new panned or coated gum products. Flavors may also be added with the sugar or sugarless coating and with the active to yield unique product characteristics.

The coating may contain ingredients such as flavoring agents, as well as artificial sweeteners and dispersing agents, coloring agents, film formers and binding agents. Flavoring agents contemplated by the present invention include those commonly known in the art such as essential oils, synthetic flavors or mixtures thereof, including but not limited to oils derived from plants and fruits such as citrus oils, fruit essences, peppermint oil, spearmint oil, other mint oils, clove oil, oil of wintergreen, anise and the like. The flavoring agents may be used in an amount such that the coating will contain from about 0.2% to about 3% flavoring agent, and preferably from about 0.7% to about 2.0% flavoring agent.

Artificial sweeteners contemplated for use in the coating include but are not limited to synthetic substances, saccharin, thaumatin, alitame, saccharin salts, aspartame, N-substituted APM derivatives such as neotame, sucralose and acesulfame-K. The artificial sweetener may be added to the coating syrup in an amount such that the coating will contain from about 0.01% to about 0.5%, and preferably from about 0.1% to about 0.3% artificial sweetener.

Dispersing agents are often added to syrup coatings for the purpose of whitening and tack reduction. Dispersing agents contemplated by the present invention to be employed in the coating syrup include titanium dioxide, talc, or any other antistick compound. Titanium dioxide is a presently preferred dispersing agent of the present invention. The dispersing agent may be added to the coating syrup in amounts such that the coating will contain from about 0.1% to about 1.0%, and preferably from about 0.3% to about 0.6% of the agent.

Coloring agents are preferably added directly to the syrup in the dye or lake form. Coloring agents contemplated by the present invention include food quality dyes. Film formers preferably added to the syrup include methyl cellulose, gelatins, hydroxypropyl cellulose, ethyl cellulose, hydroxyethyl cellulose, carboxymethyl cellulose and the like and combinations thereof. Binding agents may be added either as an initial coating on the chewing gum center or may be added directly into the syrup. Binding agents contemplated by the present invention include gum arabic, gum talha (another type of acacia), alginate, cellulosics, vegetable gums and the like.

The coating is initially present as a liquid syrup which contains from about 30% to about 80% or 85% of the coating ingredients previously described herein, and from about 15% or 20% to about 70% of a solvent such as water. In general, the coating process is carried out in a rotating pan. Gum center tablets to be coated are placed into the rotating pan to form a moving mass.

The material or syrup which will eventually form the coating is applied or distributed over the gum center tablets. Flavoring agents may be added before, during and after applying the syrup to the gum centers. Once the coating has dried to form a hard surface, additional syrup additions can be made to produce a plurality of coatings or multiple layers of hard coating.

In a hard coating panning procedure, syrup is added to the gum center tablets at a temperature range of from about 100° F. to about 240° F. Mostly, the syrup temperature is from about 130° F. to about 200° F. throughout the process in order to prevent the polyol or sugar in the syrup from crystallizing. The syrup may be mixed with, sprayed upon, poured over, or added to the gum center tablets in any way known to those skilled in the art.

In general, a plurality of layers is obtained by applying single coats, allowing the layers to dry, and then repeating the process. The amount of solids added by each coating step depends chiefly on the concentration of the coating syrup. Any number of coats may be applied to the gum center tablet. Generally, no more than about 75-100 coats are applied to the gum center pellets. The present invention contemplates applying an amount of syrup sufficient to yield a coated comestible containing about 10% to about 75% coating.

Those skilled in the art will recognize that in order to obtain a plurality of coated layers, a plurality of premeasured aliquots of coating syrup may be applied to the gum center pellets. It is contemplated, however, that the volume of aliquots of syrup applied to the gum center pellets may vary throughout the coating procedure.

Once a coating of syrup is applied to the gum center pellets, the present invention contemplates drying the wet syrup in an inert medium. A preferred drying medium comprises air. Forced drying air contacts the wet syrup coating in a temperature range of from about 70° to about 115° F. Generally, the drying air is in the temperature range of from about 80° to about 100° F. The invention also contemplates that the drying air possess a relative humidity of less than about 15 percent. Preferably, the relative humidity of the drying air is less than about 8 percent.

The drying air may be passed over and admixed with the syrup coated gum centers in any way commonly known in the art. Generally, the drying air is blown over and around or through the bed of the syrup coated gum centers at a flow rate, for large scale operations, of about 2800 cubic feet per minute. If lower quantities of material are being processed, or if smaller equipment is used, lower flow rates would be used.

For many years, flavors have been added to a sugar coating of pellet gum to enhance the overall flavor of gum. These flavors include spearmint flavor, peppermint flavor, wintergreen flavor, and fruit flavors. These flavors are generally preblended with the coating syrup just prior to applying it to the core or added together to the core in one or more coating applications in a revolving pan containing the cores. Generally, the coating syrup is very hot, about 130° to 200° F., and the flavor may volatilize if preblended with the coating syrup too early.

The concentrated coating syrup is applied to the gum cores as a hot liquid, the sugar or polyol allowed to crystallize, and the coating then dried with warm, dry air. This is repeated in about 30 to 100 applications to obtain a hard shell coated product having an increased weight gain of about 40% to 75%. A flavor is applied with one, two, three or even four or more of these coating applications. Each time flavor is added, several non-flavored coatings are applied to cover the flavor before the next flavor coat is applied. This reduces volatilization of the flavor during the coating process.

For mint flavors such spearmint, peppermint and wintergreen, some of the flavor components are volatilized, but sufficient flavor remains to give a product having a strong, high impact flavor. Fruit flavors, that may contain esters, are more easily volatilized and may be flammable and/or explosive and therefore, generally these type of fruit flavors may be pretreated in order to be able to add them to a gum coating.

By way of example and not limitation, examples of winter green type stick chewing gum formulations constructed pursuant to the present invention are in Table I.

TABLE I

| | Comparative | | Comparative | |
|---|---|---|---|---|
| | Ex. A | Ex. 1 | Ex. B | Ex. 2 |
| Sorbitol | 31.88 | 12.48 | 29.75 | 11.83 |
| Comparative Sorbitol | 36.45 | — | 39.00 | — |
| Syrup* | | | | |
| Inventive Sugarless | — | 50.0 | — | 50.0 |
| Syrup** | | | | |
| Gum Base | 25.0 | 25.0 | 27.5 | 27.5 |
| Glycerin | — | 6.0 | — | 7.0 |
| Water | 0.15 | — | 0.03 | — |
| Flavor | 1.85 | 1.85 | 1.95 | 1.95 |
| Encapsulated Flavor | 2.55 | 2.55 | 0.3 | 0.3 |
| Sweetener | 0.03 | 0.03 | 0.09 | 0.09 |
| Encapsulated High- | 2.0 | 2.0 | 1.2 | 1.2 |
| Intensity | | | | |
| Sweetener | | | | |
| Salt Solution | — | — | 0.05 | — |
| Color | 0.09 | 0.09 | 0.13 | 0.13 |
| | 100.0 | 100.0 | 100.0 | 100.0 |

*Created by coevaporation of 70% sorbitol solution, glycerin, and maltitol to give a syrup with 51.75% sorbitol, 39.5% glycerin, 2.75% water, 4% mannitol, and 2% maltitol.
**Created by coevaporation of 70% sorbitol solution, glycerin, and hydrogenated starch syrup to give a syrup with 3% water, 13.1% glycerin, 69% sorbitol, 0.5% mannitol, 11.2% maltitol, and 3.2% hydrogenated oligosaccharides having a DP of 3 or higher.

The following examples were also made.

TABLE II

| | Comparative | | |
|---|---|---|---|
| | Ex. C | Ex. 3 | Ex. 4 |
| Comparative Sorbitol Syrup* | 37.9 | — | — |
| Inventive Sugarless Syrup** | — | 55.415 | 37.0 |
| Sorbitol | 31.915 | 10.5 | 13.52 |
| Gum Base | 25.9 | 25.9 | 30.0 |
| Glycerin | — | 4.00 | — |
| Calcium Carbonate | — | — | 14.9 |
| Flavor (Peppermint) | 1.95 | 1.95 | 2.58 |
| High-Intensity Sweetener | 0.05 | 0.05 | 0.10 |
| Encapsulated High-Intensity Sweetener | 0.86 | 0.86 | 1.90 |
| Encapsulated Flavor | 0.175 | 0.175 | — |
| Lecithin | 0.10 | 0.10 | — |
| Color | 1.0 | 1.0 | — |
| Water | 0.10 | — | — |
| Salt Solution | 0.05 | 0.05 | — |
| | 100.0 | 100.0 | 100.0 |

*Created by coevaporation of 70% sorbitol solution, glycerin, and maltitol to give a syrup with 51.75% sorbitol, 39.5% glycerin, 2.75% water, 4% mannitol, and 2% maltitol.
**Created by coevaporation of 70% sorbitol solution, glycerin, and hydrogenated starch syrup to give a syrup with 3% water, 13.1% glycerin, 69% sorbitol, 0.5% mannitol, 11.2% maltitol, and 3.2% hydrogenated oligosaccharides having a DP of 3 or higher.

In Example 3, the lower level of glycerin in the inventive sugarless syrup compared to the comparative sorbitol syrup was compensated for by adding a higher level of the inventive sugarless syrup, and by adding additional glycerin to the formula. This gum was soft and flexible, and exhibited many of the same qualities as the comparative Example C chewing gum. With the higher level of syrup usage and with the lower usage of crystalline sorbitol, the overall cost of Example 3 may be less than that of comparative Example C. In addition, with the inventive syrup containing some higher hydrogenated oligosaccharides, the chewing gum of Example 3 appears to be more flexible than its comparative example.

In Example 4, used to make pellet gum, the lower level of glycerin and the use of a quantity of higher hydrogenated oligosaccharides allow the gum center formulation to be tough and robust for coating. It is anticipated that the lower glycerin level in the pellet gum formulation would also improve the shelf life of the coating. If a pellet gum example had been made with the comparative syrup, it is expected that the gum would have been too soft for coating and become easily damaged during the process.

The inventive sugarless syrup, besides being very effective for use in sugarless stick gum, can also be used in a variety of pellet gum formulations as in Table III.

TABLE III

| | Comp. | | Comp. | | Comp. | |
|---|---|---|---|---|---|---|
| | Ex. D | Ex. 5 | Ex. E | Ex. 6 | Ex. F | Ex. 7 |
| Sorbitol | 45.05 | 10.0 | 44.635 | 9.495 | 45.24 | 10.10 |
| Inventive Sugarless Syrup** | — | 40.0 | — | 40.0 | — | 40.0 |
| Gum Base | 30.0 | 30.0 | 30.0 | 30.0 | 30.0 | 30.0 |
| Calcium Carbonate | 14.75 | 14.75 | 14.90 | 14.90 | 14.90 | 14.90 |
| Glycerin | 4.0 | — | 4.0 | — | 4.0 | — |
| Mint Flavor | 3.25 | 3.25 | — | — | — | — |
| Wintergreen Flavor | — | — | 3.605 | 3.605 | — | — |
| Spearmint Flavor | — | — | — | — | 3.0 | 3.0 |
| Water | 0.95 | — | 0.86 | — | 0.86 | — |
| High-Intensity | 0.10 | — | 0.10 | — | 0.10 | — |
| Sweetener | | | | | | |
| Encapsulated High- | 1.90 | 2.0 | 1.90 | 2.0 | 1.90 | 2.0 |
| Intensity Sweetener | | | | | | |
| | 100.0 | 100.0 | 100.0 | 100.0 | 100.0 | 100.0 |

**Created by coevaporation of 70% sorbitol solution, glycerin, and hydrogenated starch syrup to give a syrup with 3% water, 13.1% glycerin, 69% sorbitol, 0.5% mannitol, 11.2%

maltitol, and 3.2% hydrogenated oligosaccharides having a DP of 3 or higher.

Sensory and other tests showed the gum centers made with the inventive sugarless syrup were similar in texture to the corresponding comparative examples.

These center formulas can be coated with a variety of alditol sweeteners such as xylitol, isomalt, maltitol, lactitol, or sorbitol to yield coated sugarless products with good quality texture. The following table gives coating formulations with maltitol for the various centers of the examples in Table III.

TABLE IV

| | Ex. 8 | Ex. 9 | Ex. 10 |
|---|---|---|---|
| Ex. 5 centers | 65.44 | — | — |
| Ex. 6 centers | — | 65.44 | — |
| Ex. 7 centers | — | — | 65.44 |
| Maltitol (from syrup) | 26.36 | 27.16 | 27.15 |
| Maltitol Powder | 4.20 | 4.20 | 4.20 |
| Gum Arabic | 2.33 | 2.39 | 2.39 |
| Titanium Dioxide | 0.63 | 0.21 | 0.21 |
| Flavor | 0.68 | 0.36 | 0.34 |
| High-Intensity Sweetener | 0.31 | 0.14 | 0.17 |
| Wax & Talc (for polishing) | 0.05 | 0.10 | 0.10 |
| | 100.0 | 100.0 | 100.0 |

### EXAMPLES 11-16

A sorbitol syrup containing a plasticizing agent and hydrogenated starch hydrolyzate and only 3% water (hereinafter “sugarless syrup”) such as used in any of Examples 1-7, may be used in a sugarless, non-cariogenic hard candy as shown in the following formulas:

### Example 11

Fruit Flavored hard candy:

| | % |
|---|---|
| Xylitol | 15.8 |
| Sorbitol | 34.8 |
| Sugarless Syrup | 38.0 |
| Water | 11.0 |
| Citric Acid | 0.3 |
| Artificial Sweetener/ | as needed |
| Fruit Flavor/Color | |

### Example 12

Butterscotch Hard Candy:

| | % |
|---|---|
| Sugarless Syrup | 53.6 |
| Sorbitol | 26.4 |
| Water | 17.66 |
| Butter | 2.06 |
| Salt | 0.12 |
| Natural and | 0.16 |
| Artificial Flavor | |

### Example 13

Hard Candy:

| | % |
|---|---|
| Sorbitol | 30.0 |
| Sugarless Syrup | 60.0 |
| Xylitol | 9.35 |
| Aspartame | 0.35 |
| Salt | 0.12 |
| Citric Acid/Flavor/Color | as needed |

Procedure: Hard candies can be made by the following procedure:

1. In a stainless steel, steam jacketed kettle, the syrup, xylitol, water, sorbitol, and salt are added and the mixture is heated to form a thick syrup.

2. The syrup is cooked and mixed until a temperature of about 300° F. and a moisture level of about 1-2% is obtained.

3. The heavy syrup is poured onto a stainless steel cooling table.

4. Citric acid, artificial ingredients, flavors and color, and butter are added and mixed by kneading.

5. The resultant product is allowed to cool to room temperature and cut as needed.

### Example 14

### Sugarless Taffy

Sugarless syrup may be used to prepare a sugar-free taffy by the following formula and procedure:

| | | | 20# (9.072 Kg) |
|---|---|---|---|
| | % As Is | % DSB | Batch |
| Syrup | 94.5 | 92.7 | 18.9 (8.573 Kg) |
| 110° F., M.P. Vegetable Oil | 5.25 | 7.0 | 1.0 (0.476 Kg) |
| Lecithin | 0.25 | 0.3 | 0.3 (0.136 Kg) |
| Flavor/Color/Acid/Sweetener | As needed | | |

Procedure:

1. Weigh sugarless syrup into an atmospheric cooker, such as a Savage open fire cooker, and cook to about 255° F. (123.9° C.). No agitation is required for this step.

2. Allow the cooked sugarless syrup to cool to about 230° F. and add fat and lecithin; fat does not have to be premelted. Mix until uniform.

3. Pour mass on oiled cooling table. Side bars may be necessary for initial cooling if table is small.

4. Work in color, flavor and acid on the slab before pulling (color and flavor may also be added on puller). Cool to plastic texture.

5. Pull cooked mass until desired texture is attained. Cut and wrap in moisture resistant packaging.

### Example 15

### Sugar-Free Caramel

Sugarless syrup may be used to prepare a sugar-free caramel by the following formula and procedure:

| | |
|---|---|
| Sugarless Syrup | 58.53% |
| Evaporated milk | 33.24 |
| Coconut Oil, 92° F. (33° C.) | 7.68 |
| Lecithin | 0.20 |
| Salt | 0.20 |
| Aspartame | 0.11 |
| Vanillin | 0.04 |
| Total | 100.00% |

Procedure:

1. Prepare aspartame slurry by mixing ⅓ ratio of aspartame to coconut oil in a high shear blender for about 30 seconds.

2. Premix all ingredients, except aspartame slurry, half of the evaporated milk and the vanillin, for 5 minutes at about 120° F. (48.9° C.).

3. Bring premix to a boil and slowly add the balance of the evaporated milk, maintaining the boil.

4. Cook to the desired texture. Final cook temperature will vary according to the cooking process. A suggested final cook temperature is about 245° F. (118.3° C.).

5. Cool the caramel to about 220° F. (104° C.) and add the aspartame slurry slowly with mixing. The vanillin should also be added at this time.

6. Slab, cut and wrap as desired.

### Example 16

### Sugarless Gum Drops

| | % |
|---|---|
| Gelatin 200 bloom type B | 7.0 |
| Crystalline sorbitol | 34.9 |
| Sugarless Syrup | 32.6 |
| Hot Water (80-90° C.) | 14.0 |
| Water | 10.0 |
| Citric Acid Solution | 1.5 |
| Fruit Flavor/Color | as needed |

Procedure:

1. Dissolve gelatin directly in hot water.

2. Cook the sugarless syrup, sorbitol and water at 115° C., and add gelatin solution.

3. Stir slowly in order to obtain a smooth homogenous mixture.

4. Remove air bubbles with deaeration equipment or other available means.

5. Add citric acid solution, flavor and color.

6. Deposit in cool and dry starch, and sprinkle a little starch onto the articles.

Temperature: 70° C. Total solids when depositing: 78° C. Brix.

7. Store the starch tray at room temperature for 24 hours.

8. After removal from the molding starch, oil the articles or coat with mannitol.

Other food items in which sugarless syrup may be used as a non-cariogenic bulking agent are:

1. Confections and frostings.

2. Dressings for salads.

3. Frozen dairy deserts and mixes.

4. Gelatins, puddings and fillings.

5. Hard candy.

6. Soft candy.

7. Baked goods and baking mixes.

It should be appreciated that the products and methods of the present invention are capable of being incorporated in the form of a variety of embodiments, only a few of which have been illustrated and described above. The invention may be embodied in other forms without departing from its spirit or essential characteristics. It will be appreciated that the addition of some other ingredients, process steps, materials or components not specifically included will have an adverse impact on the present invention. The best mode of the invention may therefore exclude ingredients, process steps, materials or components other than those listed above for inclusion or use in the invention. However, the described embodiments are to be considered in all respects only as illustrative and not restrictive, and the scope of the invention is, therefore, indicated by the appended claims rather than by the foregoing description. All changes which come within the meaning and range of equivalency of the claims are to be embraced within their scope.

1. A method of making a chewing gum composition comprising the steps of:
a) making a syrup by evaporating water from a mixture comprising:
i) an aqueous sorbitol solution containing at least 50% sorbitol;
ii) a plasticizing agent selected from the group consisting of glycerin, propylene glycol and mixtures thereof; and
iii) a hydrogenated starch hydrolyzate syrup,
iv) wherein the final evaporated syrup composition comprises less than 10% moisture, about 5% to about 20% plasticizing agent, at least 50% sorbitol, about 3% to about 25% maltitol, and at least 1.5% hydrogenated oligosaccharides having a DP of 3 or greater; and
b) mixing the syrup with gum base and additional chewing gum ingredients to produce the chewing gum composition.

2. The method of claim 1 wherein the step of mixing the syrup with the gum base comprises:
a) providing about 5% to about 95% gum base;
b) providing about 5% to about 95% of a bulking agent, the bulking agent comprising the syrup;
c) providing about 0.1 to about 15% flavoring agent; and
d) mixing the gum base, bulking agent and flavoring agent to form the chewing gum composition.

3. The method of claim 1 wherein the syrup comprises over 30% of the chewing gum composition.

4. The method of claim 1 wherein the additional chewing gum ingredients comprise a flavoring agent and a powdered bulking agent.

5. The method of claim 1 wherein the chewing gum composition is sugarless.

6. The method of claim 1 wherein the mixture, prior to evaporation, comprises about 52% to about 87% sorbitol solution, about 8% to about 20% plasticizing agent and about 5% to about 30% hydrogenated starch hydroylzate syrup.

7. The method of claim 1 wherein the syrup, after evaporation, has a water content of less than about 4%.

8. A chewing gum composition comprising a homogeneous mixture of gum base and a bulking agent wherein the bulking agent comprises an aqueous sugarless syrup comprising at least 50% sorbitol, about 3% to about 25% maltitol, about 8% to about 20% plasticizing agent and at least 1.5% hydrogenated oligosaccharides having a DP of 3 or greater and wherein the chewing gum composition has less than 2% moisture and said syrup comprises over 30% of said composition.

9. The chewing gum composition of claim 8 wherein said syrup comprises over 40% of the composition.

10. The chewing gum composition of claim 8 wherein sorbitol comprises over 60% of said syrup.

11. An aqueous syrup for use in making both stick and pellet chewing gum products comprising, on a dry basis:
a) about 60% to about 80% sorbitol,
b) about 8% to about 15% plasticizing agent selected from the group consisting of glycerin, propylene glycol and mixtures thereof, and
c) about 5% to about 30% hydrogenated starch hydrolyzate, the hydrogenated starch hydrolyzate containing hydrogenated oligosaccharides having a DP of at least 3 or greater of at least 1.5% of the dry basis of the syrup, and at least 4% maltitol on the dry basis of the syrup.

12. The aqueous syrup of claim 11 wherein the oligosaccharides having a DP of at least 3 or greater have a weight average DP of between about 4 and about 5.

13. The aqueous syrup of claim 11 wherein the syrup comprises about 3% moisture.

14. A method of making a syrup for use in both stick and pellet chewing gum products comprising the steps of:
a) providing sorbitol in an aqueous solution having a solids content of at least about 50% sorbitol and about 30% to about 50% water;
b) mixing said sorbitol solution with
i) a plasticizing agent selected from the group consisting of glycerin, propylene glycol and mixtures thereof, and
ii) a hydrogenated starch hydrolyzate syrup containing, by weight of the hydrogenated starch hydrolyzate syrup, at least 50% maltitol and at least 10% hydrogenated oligosaccharides having a DP of 3 or greater; and
c) removing moisture from said mixture to produce a syrup having a moisture content of less than about 10%.

15. The method of claim 14 wherein the mixture comprises, on a dry basis, about 8% to about 25% plasticizing agent.

16. The method of claim 14 wherein the mixture comprises, on a dry basis, about 4% to about 25% maltitol.

17. The method of claim 14 wherein the hydrogenated oligosaccharides having a DP of at least 3 or greater in the mixture have a weight average DP of between about 4 and about 5.

18. The method of claim 14 wherein the evaporation is carried out under vacuum.

19. The method of claim 14 wherein the sorbitol solution comprises about 70% sorbitol and about 30% water.

20. The method of claim 14 wherein the syrup is evaporated to a moisture content of less than about 5%.

21. The method of claim 14 wherein the syrup is evaporated to a moisture content of less than about 3%.

22. A method of making at least two different chewing gum compositions, at least one of the compositions being used to make stick chewing gum products and at least one of the compositions being used to make coated chewing gum products, comprising the steps of:
a) evaporating a mixture comprising sorbitol solution, glycerin and hydrogenated starch hydrolyzate syrup to form an evaporated sugarless syrup; and
b) mixing the evaporated sugarless syrup with a first set of additional chewing gum ingredients comprising gum base, a sugarless bulk sweetener and a flavoring agent, to form a first chewing gum composition;
c) forming the first chewing gum composition into stick chewing gum products;
d) mixing the evaporated sugarless syrup with a second set of additional chewing gum ingredients different than the first set of additional chewing gum ingredients, the second set of additional chewing gum ingredients comprising gum base, a sugarless bulk sweetener and a flavoring agent, to form a second chewing gum composition;
e) forming the second chewing gum composition into cores; and
f) coating the cores with a sugarless coating.

23. The method of claim 22 wherein the mixture of step a), after evaporation, has a solids content of about 50% to about 80% sorbitol, about 4% to about 25% maltitol, and about 1.5% to about 5% hydrogenated oligosaccharides having a DP greater than 3 and with a weight average DP of between about 4 and about 5.

24. The method of claim 22 wherein the sorbitol solution comprises about 70% sorbitol and about 30% water, and the mixture of step a), prior to evaporation, comprises about 52% to about 87% of said sorbitol solution, about 8% to about 20% glycerin and about 5% to about 30% hydrogenated starch hydrolyzate.

25. A chewing gum formulation comprising:
a) a water insoluble gum base; and
b) a water soluble portion which includes sorbitol, the sorbitol being present, at least initially, in the formulation as a syrup of aqueous sorbitol and comprising approximately 25% to about 65% by weight of the formulation, the syrup being created by coevaporating a solution that comprises, prior to coevaporation, approximately 52% to about 87% by weight aqueous sorbitol, approximately 5% to about 30% by weight of a hydrogenated starch hydrolyzate syrup and approximately 8% to about 20% by weight of a plasticizing agent selected from the group consisting of glycerin, propylene glycol and mixtures thereof.

26. The chewing gum of claim 25 wherein the syrup is created by coevaporating a solution that comprises, prior to coevaporation:
a) approximately 55% to about 75% by weight aqueous sorbitol;
b) approximately 5% to about 20% by weight hydrogenated starch hydrolyzate syrup; and
c) approximately 8% to about 15% by weight glycerin.

27. The chewing gum of claim 25 wherein the syrup includes not more than 10% water.

28. The chewing gum of claim 25 wherein the chewing gum formulation includes a crystalline form of sorbitol.

29. The chewing gum of claim 25 wherein the chewing gum formulation is sugarfree.

30. The chewing gum formulation of claim 25 wherein the water insoluble gum base is wax-free.

31. The chewing gum formulation of claim 25 wherein the chewing gum formulation includes artificial sweeteners.

32. The chewing gum formulation of claim 25 wherein the chewing gum formulation includes glycerin beside the plasticizing agent in the syrup.

33. A method for creating chewing gum compositions for use in making stick chewing gum products and chewing gum compositions used to make coated pellet chewing gum products comprising the steps of:
a) coevaporating a solution that comprises, prior to coevaporation, approximately 52% to about 87% by weight aqueous sorbitol, approximately 5% to about 30% by weight of hydrogenated starch hydrolyzate syrup, and approximately 8% to about 20% by weight of a plasticizing agent selected from the group consisting of glycerin, propylene glycol and mixtures thereof;
b) using the syrup to make a first chewing gum composition for stick chewing gum products, wherein the syrup comprises about 40% to about 65% of the first chewing gum composition; and
c) using the syrup to make a second chewing gum composition for coated pellet chewing gum products, wherein the syrup comprises about 30% to about 55% of the second chewing gum composition.

34. The method of claim 33 wherein the syrup is created by coevaporating a solution that comprises, prior to coevaporation:
a) approximately 55% to about 75% by weight aqueous sorbitol;
b) approximately 5% to about 20% by weight hydrogenated starch hydrolyzate syrup; and
c) approximately 8% to about 15% by weight glycerin.

35. The method of claim 33 wherein the syrup includes not more than 10% water.

36. A method for producing chewing gum that includes sorbitol comprising the steps of:
a) providing a syrup consisting essentially of:
i) aqueous sorbitol,
ii) a plasticizing agent selected from the group consisting of glycerin, propylene glycol and mixtures thereof, and
iii) hydrogenated starch hydrolyzate syrup,
b) evaporating water from the syrup; and
c) combining the evaporated syrup to additional chewing gum ingredients to create a chewing gum formulation.

37. The method of claim 36 wherein the syrup is created by coevaporating a solution that comprises, on a dry basis:
a) approximately 55% to about 87% by weight sorbitol;
b) approximately 4% to about 25% by weight maltitol;
c) approximately 1.5% to about 5% hydrogenated oligosaccharides having a DP of 3 or greater; and
d) approximately 5% to about 20% by weight glycerin.

38. The method of claim 36 wherein the syrup includes not more than 10% water.

39. The method of claim 36 wherein the additional chewing gum ingredients includes a crystalline form of sorbitol.

40. The method of claim 36 wherein the chewing gum formulation is sugarfree.

41. The method of claim 36 wherein the syrup comprises approximately 25% to about 65% by weight of the chewing gum formulation.

42. A sorbitol-containing product comprising a syrup consisting essentially of:
a) aqueous sorbitol,
b) a plasticizing agent selected from the group consisting of glycerin, propylene glycol and mixtures thereof; and
c) hydrogenated starch hydrolyzate syrup.

43. The product of claim 42 wherein the syrup is created by the coevaporation of a solution that comprises, prior to coevaporation:
a) approximately 52% to about 87% by weight aqueous sorbitol;
b) approximately 4% to about 25% by weight maltitol;
c) approximately 1.5% to about 5% hydrogenated oligosaccharides having a DP of 3 or greater; and
d) approximately 5% to about 20% by weight glycerin.

44. The product of claim 42 wherein the syrup includes not more than 10% water.

45. The product of claim 42 wherein the syrup comprises not more than 3% water.
